(19) United States
(12) Patent Application Publication
(10) Pub. No.: US 2009/0060027 A1
(43) Pub. Date: Mar. 5, 2009

(54) Compressed Signal Subjective Quality Ratings Prediction

(75) Inventor: Kevin M. Ferguson, Beaverton, OR (US)

Correspondence Address: MATTHEW D. RABDAU;TEKTRONIX, INC., 14150 S.W. KARL BRAUN DRIVE, P.O. BOX 500 (50-LAW), BEAVERTON, OR, 97077-0001, US

(73) Assignee: TEKTRONIX, INC., Beaverton, OR (US)

(21) Appl. No.: 11/848,043

(22) Filed: Aug. 30, 2007

(51) Int. Cl. H04N 7/12

(52) U.S. Cl. 375/240.01; 375/E07.2

(57) ABSTRACT

A no-reference subjective quality ratings predictor for a lossy compressed signal decodes the lossy compressed signal to produce a decompressed signal, and extracts from the lossy compressed signal error bounding parameters and information data. An error estimation generator converts the error bounding parameters to sensitivity test data which is combined with lossy data from an inverse compression module within the decoder to produce data with bounded errors. The data with bounded errors is converted into a sensitivity decompressed signal. The decompressed and sensitivity decompressed signals are processed by a full-reference subjective quality rating predictor to produce the subjective quality ratings for the lossy compressed signal. The information data and decompressed signal may also be input to the error estimation generator to generate the sensitivity test data in conjunction with the error bounding parameters.

### BACKGROUND

The present invention relates to signal processing, and more particularly to a no-reference (NR) method of predicting subjective quality ratings for a compressed signal.

For applications in video signal compression, storage, distribution, transmission, broadcasting, etc., determination of subjective video signal quality as affected by lossy video compression technologies is of great interest to the video industry. In many video applications only the compressed video signal is available, such as a digital television transmission received at a site remote from a transmitter or at an internet protocol television (IPTV) node or end-point. While methods exist to predict subject quality ratings of a processed (compressed/decompressed) video signal relative to a reference (original uncompressed) video signal, such as implemented in the Tektronix PQA300 Picture Quality Analyzer, manufactured by Tektronix, Inc. of Beaverton, Oreg., or described in U.S. Pat. No. 6,829,005 “Predicting Subjective Quality Ratings of Video” and U.S. Pat. No. 6,975,776 “Predicting Human Vision Perception and Perceptual Difference”—known as full-reference or FR methods, no-reference (NR) methods for predicting subjective quality ratings of a compressed video signal currently are inadequately accurate for use in most video industry applications. As an example, current NR methods generally have low correlations with, and/or high root mean square (RMS) errors relative to, subjective ratios such as Mean Opinion Score (MOS) or Difference Mean Opinion Score (DMOS).

The current methods have one thing in common: a video signal is reduced to parameters gathered in any combination from network traffic information, transport stream information, compressed video elementary stream information and/or estimates of decompressed (baseband) video objective measurements such as blocking, blur, freeze frame, noise, etc. In some cases rudimentary attempts to mimic human vision response are included, such as the inclusion of Sobel filters or other methods that emphasize edges. These parameters then are combined somehow, commonly through the use of weighted sums of these, to produce a final score. The weights are chosen to maximize correlation with DMOS scores for an ensemble of reference video clips with representative video signal compression artifacts. Some of these methods are implemented in various products currently on the market.

More recently NR objective parametric measurement estimates have included peak signal-to-noise ratio (PSNR). However PSNR has been shown not to be a good indicator of subjective ratings relative to other methods, even when the reference video signal is available.

There are two issues with the present NR methods:
1) The parametric measurement estimates tend to remove context of error sensitivity, i.e., location of error in a video frame, and/or they don't take advantage of information that may be used to determine upper and lower bounds of errors; and
2) The methods do not include known behavior of the human vision system, such as adaptations causing non-linear response accounting for masking, visual illusions and generally drastically varying sensitivities in spatiotemporal response.

What is desired is an NR method that addresses the weaknesses of prior NR methods in order to have a more robust and accurate estimate or prediction of subjective quality ratings for a compressed signal.

### SUMMARY

Accordingly, embodiments of the present invention provide a no-reference (NR) apparatus and method for predicting subjective quality ratings for a lossy compressed signal, especially a compressed video signal. A decoder converts the lossy compressed signal to a decompressed signal, and extracts from the lossy compressed signal error bounding parameters and information data. An error estimation generator converts the error bounding parameters to sensitivity test data which is combined with lossy data from an inverse compression module within the decoder to produce data with bounded errors. The data with bounded errors is converted into a sensitivity decompressed signal. The decompressed and sensitivity decompressed signals are processed by a full-reference subjective quality rating predictor to produce the subjective quality ratings for the lossy compressed signal. The information data and decompressed signal may also be input to the error estimation generator to generate the sensitivity test data in conjunction with the error bounding parameters. For compressed video signals the information data may be discrete cosine transform (DCT) coefficients and the error bounding parameters may be a quantization table and scaling information.

The objects, advantages and other novel features of the present invention are apparent from the following detailed description when read in conjunction with the appended claims and attached drawing views.

### BRIEF DESCRIPTION OF THE FIGURES

FIG. 1 is a generic block diagram view of a lossy signal compression method according to the prior art.

FIG. 2 is a generic block diagram view of a decompression method for a compressed signal according to the prior art.

FIG. 3 is a generic block diagram view of a no-reference method for predicting subjective quality ratings of a compressed signal according to an embodiment of the present invention.

FIG. 4 is a block diagram view of an MPEG video signal compression method according to the prior art.

FIG. 5 is a block diagram view of a no-reference method for predicting subjective quality ratings of an MPEG compressed video signal according to an embodiment of the present invention.

### DETAILED DESCRIPTION

As described below, embodiments of the present invention make a better estimate of the sensitivity of the human vision response to bounded and localized errors caused by particular error mechanisms within signal compression methods, and may be applied to any lossy compression methods for video signals, audio signals or other human sensory stimuli. The following includes a generic form of the NR method of the present invention, with mappings to specific examples for discrete cosine transform (DCT) based video signal compression methods such as MPEG-2, AVC/H.264, VC-1, etc. and also for wavelet based methods such as JPEG-2000.

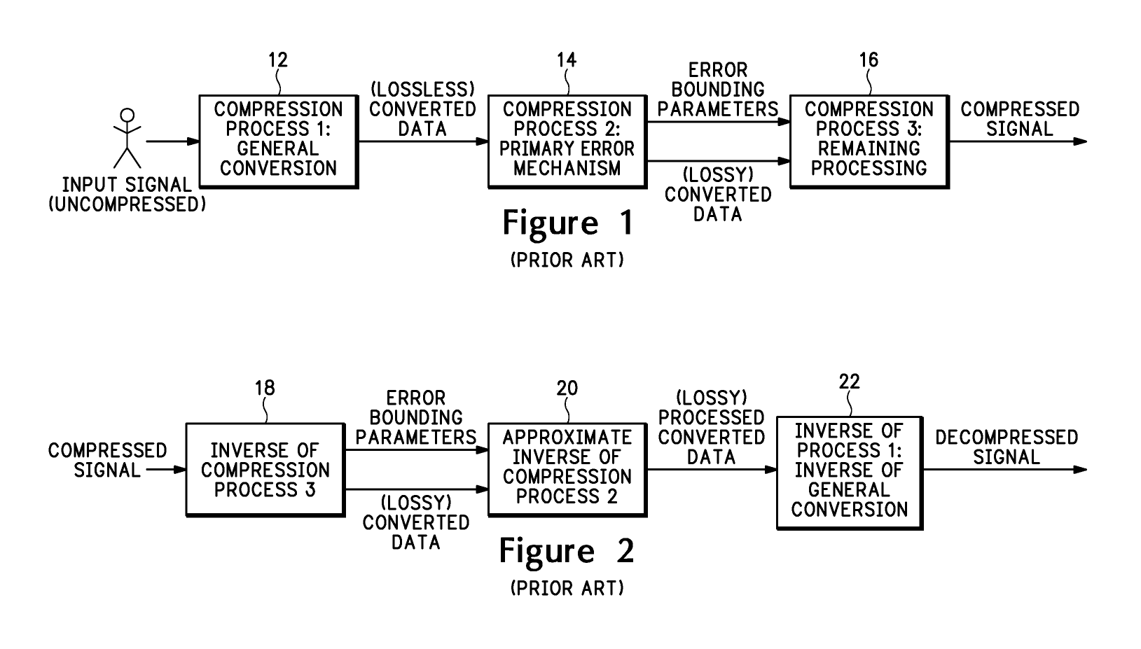

Referring now to FIGS. 1 and 2 generic codec block diagrams are shown for lossy signal compression (FIG. 1) and decompression (FIG. 2) respectively. An uncompressed signal is input to a general conversion block 12 representing a first process (“Process 1”), which may include any conversion process prior to error introduction, to produce lossless converted data. Linear transforms, such as fast Fourier transforms (FFTs), discrete cosine transforms (DCTs), Karhunen-Loeve (KL) transforms, wavelet transforms and other methods primarily used for entropy compaction, are among conversion methods represented by the general conversion block 12. The lossless converted data from the general conversion block 12 is input to a lossy compression block 14 that represents the primary error mechanism (“Process 2”). For DCT based transforms, such as MPEG-2, AVC/H.264, VC-1, etc. this generally represents DCT coefficient quantization error. Output from the lossy compression block 14 are error bounding parameters, such as those that describe the quantization used—quantization table, scale, etc., and lossy converted data. The error bounding parameters may be used for determining bounds of errors introduced by the lossy compression block 14. For example the difference between each quantized level may be used as an upper bound for the error associated with a given quantization level represented by each data value in the lossy converted data output from the lossy compression block 14. The error bounding parameters and lossy converted data from the lossy compression block 14 are then input to a final compression block 16. The final compression block 16 represents all subsequent processing (“Process 3”) including entropy encoding, etc. to produce a compressed signal corresponding to the input uncompressed signal.

FIG. 2 shows the decompression blocks 18, 20, 22 that perform on the compressed signal generally inverse or approximate inverse processes for each of the blocks 12, 14, 16 of the compression process shown in FIG. 1. However the errors introduced in the lossy compression block 14 are not removed by the inverse lossy compression block 20. This is the primary source of subjective quality reduction in lossy compression schemes. For example the quantization parameters for quantized DCT coefficients (table, scale, non-linear vs linear quantization selection, etc.) are used to convert scaled and quantized DCT coefficients to the original scale with the quantization error. The resulting decompressed signal from the final inverse compression block 22 corresponds to the uncompressed input signal, but with errors introduced by the lossy compression block 14 of the compression process of FIG. 1.

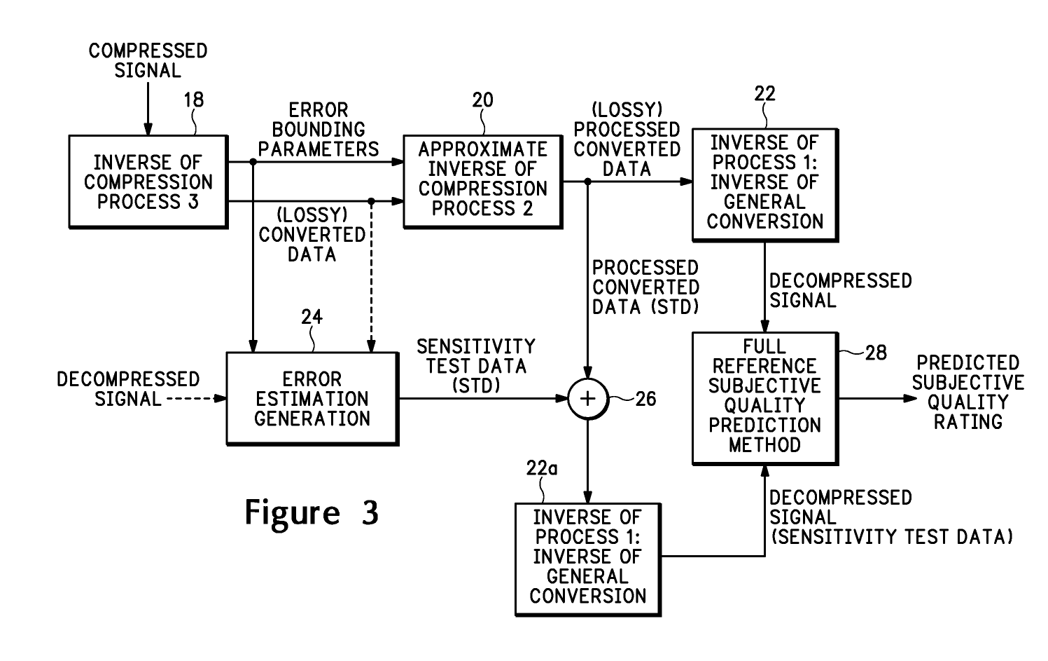

Referring now to FIG. 3 the generic decompression block diagram of FIG. 2 is modified to provide a generic implementation of an embodiment of the present invention. FIG. 3 includes the block diagram of FIG. 2 with the generic inverse compression blocks 18, 20, 22 along with additional blocks, as described below. An error estimation generator 24 receives at least the error bounding parameters, and may also receive the lossy converted data from the inverse Process 3 block 18 as well as the decompressed signal from the inverse Process 1 block 22. The error estimation generator 24 generates error sensitivity measurement test stimuli, represented as sensitivity test data (STD). The sensitivity test data, i.e., representing bounded errors, and lossy processed converted data from the inverse Process 2 block 20 are combined in an adder 26 to produce processed lossy converted data with STD. The two sources of processed lossy converted data are input to respective inverse Process 1 blocks 22, 22a to produce respective decompressed signals, one with sensitivity test data added. The two decompressed signals from the respective inverse Process 1 blocks 22, 22a are input to a conventional full-reference (FR) subjective quality prediction block 28, where the decompressed signal with the sensitivity test vector is the test signal and the other decompressed signal is the reference signal, or vice versa. The quality prediction block 28 takes the two decompressed signal inputs, which differ by an amount with known error bounds approximately equal to that between the original uncompressed signal and the original decompressed signal, and produces a predicted subjective quality rating for the compressed signal. The quality prediction block 28 makes use of a human vision model algorithm such as used in the FR methods discussed initially above.

One advantage of the above-described method is that the differential signal caused by the error introduced in the lossy compression block 14 may be assessed in the context of the signal itself. For video signal compression, an MPEG-2 quantization table is generated during coding from which the expected quantization error of a particular DCT coefficient may be determined in the decoder, such as by using any method for interpolation of a DCT coefficient histogram including but not limited to the PSNR method referenced above.

More specifically if the expected value for the quantization error of the highest frequency horizontal cosine basis vector is determined to be 25% of the amplitude reconstructed in the processed lossy converted data from the inverse Process 2 block 20, a random noise generator (RNG), set to have an expected RMS value of 25% and probability density function corresponding to the interpolated DCT coefficient histogram, may be used as the error estimation generator 24 to generate the sensitivity test data to be added to the particular coefficient. Likewise each DCT coefficient has error added such that the total RMS error signal added to the DCT coefficients is equal to the expected RMS error due to the original quantization. Once decompressed by the inverse Process 1 block 22a, the sensitivity decompressed signal has a PSNR equal to that estimated from the prior art methods referenced above.

The perceptual difference between the sensitivity decompressed signal and the other decompressed signal is then assessed by the output block 28 using the full-reference (FR) method, preferably including a human vision model as indicated above. For small perceptual errors, depending upon the signal content, artifacts may be imperceptible, while others may be quite noticeable. As an example, scene changes in a video signal may reduce perceptual sensitivity to artifacts, while the same error as measured by PSNR on a static “flat” low level may be quite perceptible. The absolute difference error between the two decompressed signals from the inverse Process 1 blocks 22, 22a is processed by the output block 28 to produce a predicted subjective quality rating that is comparable to the current FR techniques produced from comparing the original uncompressed input signal with the corresponding decompressed signal for the small perceptual errors. For large perceptual errors the predicted subjective quality rating from the output block 28 provides a marked improvement over current NR techniques.

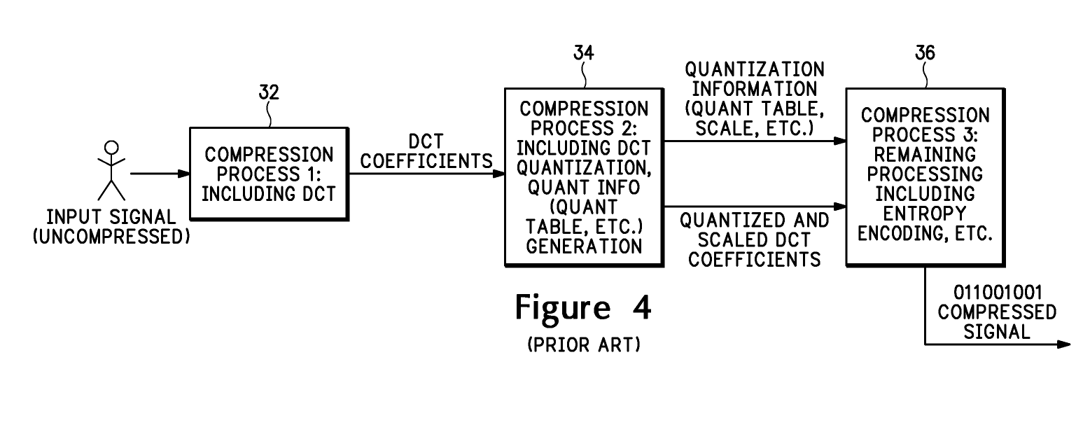

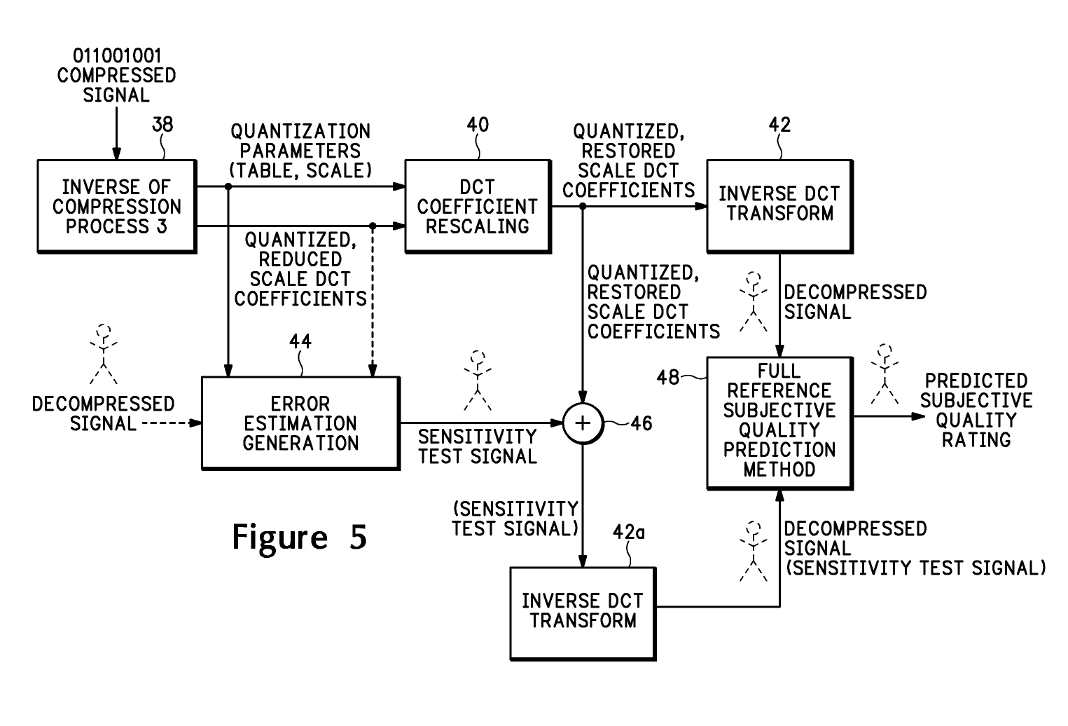

A specific example is exemplified by the MPEG video compression process shown in FIG. 4 as analyzed by the corresponding NR subjective quality rating process shown in FIG. 5. In the compression process an input linear compression block 32 includes a DCT process that produces DCT coefficients for an input uncompressed video signal. The DCT coefficients are input to a lossy compression block 34 that includes DCT quantization and generates quantization information, such as a quantization table, scaling, etc. Output from the lossy compression block 34 are the quantization information that contains error bounding parameters and quantized and scaled DCT coefficients, i.e., lossy converted data. The quantization information and the quantized and scaled DCT coefficients are input to a final compression block 36 for any further processing including entropy encoding, etc. to produce an MPEG compressed video signal.

The MPEG compressed video signal is then input to decoder, as described above, with the added blocks to provide subjective quality ratings for the MPEG compressed video signal. An inverse Process 3 block 38 receives the MPEG compressed video signal to recover the quantization information and quantized, scaled DCT coefficients. The quantization information and quantized, scaled DCT coefficients are input to an inverse Process 2 block 40 which provides DCT resealing to restore the scale of the quantized DCT coefficients that include the lossy errors. The restored DCT coefficients are then input to an inverse Process 3 block 42 in the form of an inverse DCT transform to produce the decompressed video signal that contains errors relative to the original uncompressed video signal input to the coder of FIG. 4. The quantization parameters, and possibly the quantized, scaled DCT coefficients and decompressed video signal, are input to an error estimation generator 44 to produce a sensitivity test signal in the form of quantization error bounded restored scale random error for sensitivity. The sensitivity test signal is combined with the restored DCT coefficients in an adder 46 and the result is input to another inverse Process 3 block 42a in the form of an inverse DCT transform to produce a sensitivity decompressed video signal. The two decompressed video signals from the respective inverse DCT transforms 42, 42a are input to an FR subjective quality prediction module 48 to provide a predicted subjected quality rating for the compressed MPEG video signal.

The quantization information may be in the form of a look-up table (LUT) that contains a quantization error, shift(n), for each DCT coefficient, c(n). The error estimation generator 44 accesses the LUT and produces restored scale error values, 2^{shift(n)}−1, as the sensitivity test signal. These values represent the worst case quantization errors. Alternatively statistical weighting may be used for the worst case quantization errors by multiplying them with a factor rnd(n) where rnd(n) has a constantly changing output with desired statistics, such as Gaussian, random noise, etc.

Since the DCT coefficients are generated on a block basis within each frame of the video signal, the decompressed video signal may be used by the error estimation generator to further modify the sensitivity test signal to account for discontinuities at block boundaries, as one example. More complex error estimation algorithms may be used to also take into account the quantized, scaled DCT coefficients together with the quantization information and/or decompressed MPEG signal. The significant point is that the bounded error information contained in the error bounding parameters, such as the quantization information, is used to generate a sensitivity test signal so that the resulting two decompressed video signals, when analyzed by the FR subjective quality prediction block 28, 48, produce predicted subjective quality rating that closely approximates current FR techniques for small perceptual errors, and which is a marked improvement over current NR techniques for large perceptual errors. Thus the resulting subjective quality rating for the compressed signal from the above-described NR technique produces a value that is robust and is a more accurate estimate of the quality of the compressed signal compared to prior NR techniques.

Thus embodiments of the present invention provide a no-reference subjective quality rating for a compressed signal by using bounded error parameters generated by a lossy compression block in a compression coder and transmitted to a decompression decoder to generate estimated bounded error values as a sensitivity test signal that is added to processed lossy converted data corresponding to the input to the coder's lossy compression block. The processed lossy converted data, with and without the senstivity test signal, are processed to produce corresponding decompressed signals for comparison with each other in a full-reference subjective quality rating predictor to produce a predicted subjective quality rating for the compressed signal.

What is claimed is:

1. A no-reference method of predicting subjective quality ratings for a lossy compressed signal comprising the steps of:
decoding the lossy compressed signal via an inverse compression process to produce a decompressed signal, and to extract error bounding parameters included within the lossy compressed signal;
generating sensitivity test data as a function of the error bounding parameters;
combining the sensitivity test data with lossy data from the inverse lossy compression process to produce data with bounded errors;
converting the data with bounded errors to a sensitivity decompressed signal; and
predicting the subjective quality ratings from the decompressed and sensitivity decompressed signals using a full-reference subjective quality prediction process.

2. The method as recited in claim 1 wherein the decoding step comprises the step of converting the lossy data to the decompressed signal.

3. The method as recited in claim 1 wherein the generating step includes the step of generating the sensitivity test data as a function of the error bounding parameters and the decompressed signal.

4. The method as recited in claim 1 wherein the generating step includes the step of generating the sensitivity test data as a function of the error bounding parameters and information data extracted from the lossy compressed signal.

5. The method as recited in claim 4 wherein the generating step includes the step of generating the sensitivity test data additionally as a function of the decompressed signal.

6. The method as recited in claim 1 wherein the lossy compressed signal comprises an original video signal compressed using a discrete cosine transform (DCT) function and quantization to produce quantized DCT coefficients as information data and a quantization table and scaling information as the error bounding parameters.

7. The method as recited in claim 6 wherein the lossy data comprises restored DCT coefficients and the data with bounding errors comprises the restored DCT coefficients combined with the sensitivity test data, the restored DCT coefficients including quantization errors.

8. The method as recited in claim 1 wherein the lossy compressed signal comprises an original signal compressed using a wavelet-based compression process.

9. A no-reference system for predicting subjective quality ratings for a lossy compressed signal comprising:
means for decoding the lossy compressed signal via an inverse compression process to produce a decompressed signal, and to extract error bounding parameters included within the lossy compressed signal;
means for generating sensitivity test data as a function of the error bounding parameters;
means for combining the sensitivity test data with lossy data from the inverse lossy compression process to produce data with bounded errors;
means for converting the data with bounded errors to a sensitivity decompressed signal; and
means for predicting the subjective quality ratings from the decompressed and sensitivity decompressed signals using a full-reference subjective quality prediction process.

10. The system as recited in claim 9 wherein the decoding means comprises means for converting the lossy data to the decompressed signal.

11. The system as recited in claim 9 wherein the generating means includes means for generating the sensitivity test data as a function of the error bounding parameters and the decompressed signal.

12. The system as recited in claim 9 wherein the generating means includes means for generating the sensitivity test data as a function of the error bounding parameters and information data extracted from the lossy compressed signal.

13. The system as recited in claim 12 wherein the generating means includes means for generating the sensitivity test data additionally as a function of the decompressed signal.

14. The system as recited in claim 9 wherein the lossy compressed signal comprises an original video signal compressed using a discrete cosine transform (DCT) function and quantization to produce quantized DCT coefficients as information data and a quantization table and scaling information as the error bounding parameters.

15. The system as recited in claim 14 wherein the lossy data comprises restored DCT coefficients and the data with bounding errors comprises the restored DCT coefficients combined with the sensitivity test data, the restored DCT coefficients including quantization errors.

16. The system as recited in claim 8 wherein the lossy compressed signal comprises an original signal compressed using a wavelet-based compression process.

17. An apparatus for predicting subjective quality ratings for a lossy compressed signal comprising:
a decoder having the lossy compressed signal as an input and a decompressed signal as a first output and error bounding parameters extracted from the lossy compressed signal as a second output;
an error estimation generator having the error bounding parameters as an input and having sensitivity test data as an output, the sensitivity test data being a function of the error bounding parameters;
a combiner having the sensitivity test data as a first input and lossy data from the decoder derived from the lossy compressed signal as a second input, and having data with bounded errors as an output;
a converter having the data with bounded errors as an input and having a sensitivity decompressed signal as an output; and
a quality predictor having the decompressed and sensitivity decompressed signals as inputs and the subjective quality ratings as an output.

18. The apparatus as recited in claim 17 wherein the error estimation generator generates the sensitivity test data as a function of the error bounding parameters and the decompressed signal.

19. The apparatus as recited in claim 17 wherein the error estimation generator generates the sensitivity test data as a function of the error bounding parameters and information data extracted from the lossy compressed signal by the decoder.

20. The apparatus as recited in claim 19 wherein the error estimation generator generates the sensitivity test data further as a function of the decompressed signal.
